(19) United States
(12) Patent Application Publication
(10) Pub. No.: US 2017/0030248 A1
(43) Pub. Date: Feb. 2, 2017

(54) Continuous Fiber Molded Part

(71) Applicant: ISOLITE GmbH, Ludwigshafen (DE)

(72) Inventors: Michael Knoll, Birkenau (DE); Karl-Christian Regent, Wolfenbuttel (DE)

(21) Appl. No.: 15/219,544

(22) Filed: Jul. 26, 2016

(30) Foreign Application Priority Data
Jul. 28, 2015 (EP) 15178693.6

(51) Int. Cl. F01N 13/18; C03C 25/42; C03B 9/30; C03B 19/12; C03B 19/02

(52) U.S. Cl. CPC F01N 13/1861; C03B 19/12; C03B 19/02; C03B 9/30; C03C 25/42; F01N 2530/18

(57) ABSTRACT

Continuous fiber molded part for silencers or mufflers comprising a continuous fiber and a coat of inorganic binder, wherein the coat encloses the continuous fiber.

### FIELD OF THE INVENTION

The invention relates to a formed thermo-acoustically active continuous glass fiber molded part with an inorganic binder as well as a method for its production. The main field of application comprises the silencer sector in the automotive and commercial vehicle industry field, but also other related fields.

### BACKGROUND OF THE INVENTION

Various technologies for filling filling material into silencers in the automotive sector in the prior art may be described by way of example.

A) Directly Filling Loose Continuous Fibers into a Silencer

When directly filling a silencer, the loose continuous glass fibers are by use of compressed air blown through a nozzle into the silencer. Shaping of the fibrous material arises due to the individual restrictions of the system, in particular by its cavities. However, directly filling a silencer has the following drawbacks:
Inhomogeneous distribution of material in the system is likely.
Associated therewith, the insulating effect, in particular the acoustic effect, can fluctuate.
So-called hot spots can form, which are undesirable.
Undesirable setting behavior of the material within the system is possible.
Complex geometries can be realized only with difficulty.
Any control of the degree of filling can typically be effected only via the weight, whereas the filling density is difficult to control.
Protruding fibers can arise which can make welding difficult.

A hotspot is to be understood as being a location on a component which unintentionally has a higher temperature than locations in its surrounding area caused by the lack of or insufficient insulating material or the lack of or insufficient insulating properties, respectively, as compared to the surrounding area.

The following model is suitable for explaining the term setting behavior: Imagine a circular cavity which is homogeneously filled with insulating material, so that the volume of the cavity corresponds to the volume of the insulating material. In the event of massive setting behavior, e.g. due to vibration or the like, the insulating material is compacted or it accumulates locally, so that the cavity volume is then greater than the insulating material volume. One speaks of the insulation settling.

### b) Introduction in PP or PE Bags/Socks

When introducing the continuous fiber into the silencer by way of plastic bags or plastic socks, the shaping of the fibers arises due to the restrictions of these bags or socks. They are then inserted or pressed into the intended position in the silencer. Furthermore, they can as a mounting aid also be wrapped around a tube and inserted into the silencer. The plastic bags or plastic socks can there be used as an installation aid. However, the introduction of the continuous fibers into the silencer by way of plastic bags or plastic socks has the following drawbacks:
The silencer becomes hot during operation. This can cause increased emissions during operation of the silencer due to the plastic burning. Such silencers frequently obtain no approval from some car manufacturers for the installation in their vehicles.
Complex geometries are with this method typically very difficult to obtain
Further assembly aids are typically necessary
Undesirable setting behavior is possible
Positioning the plastic bags or socks is difficult.
   c) Continuous Fiber Molded Parts with an Organic Binder

With continuous fiber molded parts with an organic binder, such as phenolic resin, epoxy resin, unsaturated polyester resin, starch, etc., the fibers obtain their shape by wetting and curing the organic binder. After shaping, the parts are inserted into the silencer. This method has the following drawbacks:
The silencer becomes hot during operation. This can cause increased emissions during operation of the silencer due to the organic substances burning, for example, the phenolic resin. Such silencers frequently obtain no approval from some car manufacturers.
Long curing times arise in the fabrication process.
The organic material is typically present in the entire continuous molded part.
Blow-out protection may be necessary.

A blow-out prevention is to be understood as follows: Exhaust tubes extending within the silencer in part have perforations which allow the inserted fibers to blow out into the environment. To avoid blow-out, these perforated tubes are coated with wire wool, so that the exhaust gas can pass in one direction and the fibers can be stopped in the other direction.

### d) Mechanically Stabilized Continuous Fiber Mats

First option: The continuous fiber is mechanically stabilized in a sewing process at certain points and thereby formed to a flexible endless molded part.

Second option: The textured endless fiber is introduced into a two-dimensional structure and subsequently mechanically stabilized, for example, by way of so-called needling.

Needling is in the production of non-wovens understood to be the connection by way penetration by many small individual needles with small barbs.

However, both methods have the following drawbacks:
Protruding fibers can arise on the outer sides which can be problematic.
The mats thus stabilized typically are not inherently stable.
It is often very difficult to optimally fill complex geometries

### SUMMARY OF THE INVENTION

In view of the problems of prior art it is the object of the present invention to provide a simpler option for a continuous fiber molded part and for the production of the continuous fiber molded part, as well as a method for the fabrication of a silencer using this continuous fiber molded part and to thereby reduce or even avoid the prior art drawbacks mentioned.

This object is satisfied by a continuous fiber molded part according to an embodiment and by a method for the production of a continuous fiber molded part according to another embodiment and by a method for the fabrication of silencers according to a further embodiment and a respectively fabricated silencer according to yet another embodiment.

The problem with conventional inorganic binders has previously been that they can either not be used for the case of application for the reason that the binding forces on continuous fibers are not sufficient, or—which is problematic with a sol-gel system—the high basicity of the system attacks the fibers chemically and can destroy them. It has frequently been attempted to use sol-gel systems based on water glass and silica sol, but this was always associated with the fiber being damaged. The inventors have established a sol-gel binder system which does not cause this effect due to its lower basicity. A composition of the binder has been found which has a lower pH-value than conventional sol-gel systems based on silica sol and water glass, and thereby also has a lower chemical basicity.

The invention provides a continuous fiber molded part for silencers comprising a continuous fiber and a coat made of inorganic binder, wherein the coat encloses the continuous fiber.

This invention relates to a formed thermo-acoustically active continuous glass fiber molded part with an inorganic binder, without chemically attacking the fibers and without the addition of organic additives such as phenolic resin, epoxy resin, unsaturated polyester resin, PP bags, PE bags or PE/PP socks and without further mechanical stabilization, such as by needling, sewing or other textile processes. The main field of application comprises the silencer or muffler sector in the automotive and commercial vehicle industry, but also other related fields. Positive properties known from prior art are there combined and negative properties practically avoided.

The inorganic mineral-based binder affects the fibers neither chemically nor mechanically and ensures that no additional emissions can arise, possibly due to organic binder or organic auxiliary structures burning, such as PP/PE bags/socks. Restrictions due to existing emission standards can then also be avoided.

The continuous molded part due to the outer coat is inherently stable while at the same time being self-damping due to the fibrous core.

A filament with a virtually unlimited length is referred to as a continuous fiber. It can comprise a bundle (multifilament or multifil) made of several individual filaments.

The continuous fiber can be an open or an effect-textured fiber. It can be a glass fiber such as an E or ECR glass fiber. However, it is also possible to use fiber types such as basalt, ceramic, aramid, silica, carbon, or Kevlar fibers. Furthermore, the continuous fiber can be given as a mat or scrim.

The continuous molded part is typically composed of an open or effect-textured continuous fiber made of E; ECR—or similar glass, enclosed in a coat of colloidal mineral. This means that the open pore inorganic outer layer based on nano-technology can give the continuous molded part its stability while at the same time having an acoustically open surface. The enclosed continuous fiber can there be present untreated in the interior of the coat, in particular at a defined density. Flawless thermal as well as acoustic operation can thereby be ensured.

A normal fiber strand, a roving—after production in the glass melting tank—comprises a bundle or strand of filaments that are substantially arranged in parallel or combined, so-called continuous fibers. The number of filaments for every fiber strand is typically given in 1000 filaments equal to 1 K. By opening the fiber strand, single filaments can be made visible. A textured glass strand in contrast to a normal fiber strand has a slight twist. In an effect-textured glass fiber strand, in contrast to the textured glass fiber strand, the glass filaments are extremely swirled without the strand interconnection being lost. This has the effect that already a slight connection is created by the swirled filaments when such a strand is tangled.

The inorganic binder can comprise a colloidal mineral, in particular a sol-gel based on water glass and silica sol.

The sol-gel chemistry used can be based on interplay of different types of water glass and different types of silica sol. Further soluble precursors, i.e. starting materials, for sol-gel processes are, for example, sodium silicates (water glass), soluble oxides or alkoxides, i.e. alcoholates, of glass-forming compounds such as SiO₂, TiO₂, ZrO₂,, and hydroxides such as boric acid, H₃BO₃, or sodium hydroxide, NaOH. For pure SiO2, however, for example, silicic acid esters are used. Further products that can be produced from sol-gel chemistry include aerogels, xerogels, powder, fiber and many more. The term sol-gel process is to be understood as a general term for methods of producing non-metallic inorganic or hybrid polymeric materials from colloidal dispersions.

Water glass can be sodium and/or potassium and/or lithium water glass, wherein the silica sol particle size can be between 7 and 40 nm.

One or more of sodium silicate, potassium silicate or lithium water glass can be used as water glass. The particle size of the silica sol particles, i.e. substantially the diameter of these particles, can be between 7 and 40 nm. This range can in particular be divided into two more ranges, namely firstly, particles having a size of about 7-20 nm in diameter or particles having a size of about 30-40 nm in diameter. A mixture of particles having diameters from the first range and of particles having diameters from the second range is possible. The advantage of the selection of particles in terms of a mixture with diameters of two typically different and non-overlapping ranges lies in the bimodal modification of silica sols, i.e. the interaction of two different particle sizes can effect optimum surface modification.

The water glass content of the sol-gel can amount to 25-75%, typically to 35-65%, and in particular to 45-55%. The silica sol content of the sol-gel can likewise amount to 25-75%, typically to 35-65%, and in particular to 45-55%. Furthermore, the sol-gel can be mixed with water, a portion of water can therefore be added. The water can there be plain water and/or distilled water or it can be a mixture of both. The mixture of the water portion with the sol-gel can be given at a mixing ratio of 0-1:6, typically of 1:2 and in particular of 1:1. Appropriate dilution of the sol-gel can thereby be obtained.

These specifications for the water glass and the silica sol are to be understood as mass percentages of the respective raw material.

One problem with conventional inorganic binders has previously been that they could either not be used for the case of application for the reason that the binding forces on continuous fibers are not sufficient, or—which is problematic with a sol-gel system—the high basicity of the system bears the risk that the fibers are chemically attacked or even destroyed. It has frequently been attempted to use sol-gel systems based on water glass and silica sol, but this was always associated with the fiber being damaged. The inventors have established a sol-gel binder system which does not cause this effect due to its lower basicity. A composition of the binder has been found which has a lower pH-value than conventional sol-gel systems based on silica sol and water glass, and thereby also has a lower chemical basicity.

For the pH-value of the sol-gel, 8≦pH ≦9 may apply.

With this pH-value a sufficiently low basicity, also known as alkalinity, can be obtained, whereby the fiber can be particularly well protected.

The invention further provides a method for producing a continuous fiber molded part comprising: providing a continuous fiber, which in particular has a predefined density in a supply volume; providing an inorganic binder; applying the inorganic binder onto the continuous fiber so that the continuous fiber is enclosed in a coat-like manner; curing the inorganic binder by applying heat.

Curing can with complex geometries also take place in the tool. The tool can there after curing be removed so as to release the formed continuous fiber molded part.

The continuous fiber can there again be an open or an effect-textured fiber. It can there also be a glass fiber such as an E or ECR glass fiber. However, it is also possible to use fiber types such as basalt, ceramic, aramid, silica, carbon, or Kevlar fibers. Furthermore, the continuous fiber can be given as a mat or scrim.

The method can further comprise forming the continuous fiber molded part according to a predefined mold by way of cutting with a tool having severing edges, wherein the tool is typically heated by supplying heat.

The predefined mold is there to refer to the shaping of the continuous fiber molded part. A mold within the meaning of a shaping shell can be used as a tool. The tool can be, for example, a heated mold consisting of two halves, a punch and a die. The edges of the fibers can therewith be separated and simultaneously closed. Very complex components can be realized with the aid of such a shaping tool, for example, for internal geometries.

The continuous molded part can be produced with a heated tool having pinching, i.e. severing edges, meaning made to take the desired shape.

Defined edges can be created during cutting. A high degree of fitting accuracy of the molded part can thereby be obtained so that problems in terms of shape or fit can be avoided when welding the silencer.

As already mentioned, the continuous molded part is due to the inherently stable outer coat while at the same time being self-damping due to the fibrous core. For example, certain deformations for installing the molded part can thereby be performed without destroying or impairing the latter, while simultaneously the initial state is regained after installation. This property enables optimal installation.

For example, the continuous fiber molded part can be molded to geometric shapes, in particular spherical or elliptical.

In this context spherical shapes are still relatively simple geometries. However, for example, very complex three-dimensional geometries can also be produced. The resulting continuous endless molded part should preferably have no undercut. Otherwise it would, for example, need to be divided into a sufficient number of parts until no undercut is given.

In the method, curing can be done by supplying heat at a temperature of at least 100° C., preferably between 250° C. and 400° C.

Typically a maximum of 750° C. is possible for the temperature of the curing process, where the thermal limit of the continuous fiber is crucial. The temperatures for curing are typically between 250° C. and 400° C.

In the method, the inorganic binder can comprise a colloidal mineral, in particular sol-gel based on water glass and silica sol.

The sol-gel can in particular be based on water glass and silica sol, see above.

Due to the mineral binder typically being applied externally, no substantial curing time is typically needed as it is only applied in a fine colloidal dispersion on the outer side of the fiber body. The continuous fiber molded part can therefore be produced rapidly.

In the method, the water glass content of the sol-gel can amount to 25-75%, typically to 35-65%, and in particular to 45-55%. The silica sol content of the sol-gel can amount to 25-75%, typically to 35-65%, and in particular to 45-55%. Furthermore, the sol-gel can be mixed with water, a portion of water can therefore be added. The water can be plain water and/or distilled water or it can be a mixture of both. The mixture of the water portion with the sol-gel can be given at a mixing ratio of 0-1:6, typically of 1:2 and in particular of 1:1.

In the method, the pH-value of the sol-gel can typically be in the range of 8-9.

The invention also provides a method for the fabrication of silencers, the method comprising; providing a first coat shell; providing a second coat shell or a component directly conducting hot gas; providing a continuous fiber molded part as described above; introducing the continuous fiber molded part between the first and the second coat shell or between the first coat shell and the component directly conducting hot gas.

The continuous fiber molded part or the continuous fiber molded parts can be used in the fabrication of silencers. These can be high-temperature silencers. A gap is there to denote a space which is provided, for example, between the coat shells or between the first coat shell and the component directly conducting hot gas. The continuous fiber molded part can be introduced into this gap. Either one or a few continuous fiber molded parts created in advance and suitably shaped can be introduced or, in the event of a bag-like formation, the gap can be filled by a plurality of continuous fiber molded parts, for example, spherical continuous fiber molded parts.

Very complex geometries having a defined density can be produced in the fabrication process. This prevents the formation of hot spots, undesired setting behavior and inhomogeneous distribution. This results in continuously excellent acoustic absorption and thermal insulation behavior. Any common filling level can be implemented with narrow tolerances.

In the method, the introduction of the continuous fiber molded part can comprise the insertion and/or the casting and/or the blowing and/or the pushing in between the first and second coat shell or between the first coat shell and the component directly conducting hot gas.

The continuous fiber molded part can therefore be introduced into the silencer in a particularly simple manner. In particular no wrapping of elements is necessary.

The invention further provides a silencer which is fabricated according to the method described.

Embodiments of the invention are described hereafter with reference to the figures. The embodiments described are to be considered in all aspects as being only illustrative and not restrictive and various combinations of the features specified are comprised by the invention.

### BRIEF DESCRIPTION OF THE DRAWINGS

FIG. 1 schematically illustrates various types of fiber strands.

FIG. 2 schematically illustrates a partial view of a molded part in the silencer.

FIG. 3 schematically illustrates a partial view of a molded part in the silencer.

FIG. 4 schematically illustrates a view of a three-dimensionally shaped molded part.

### DETAILED DESCRIPTION OF THE INVENTION

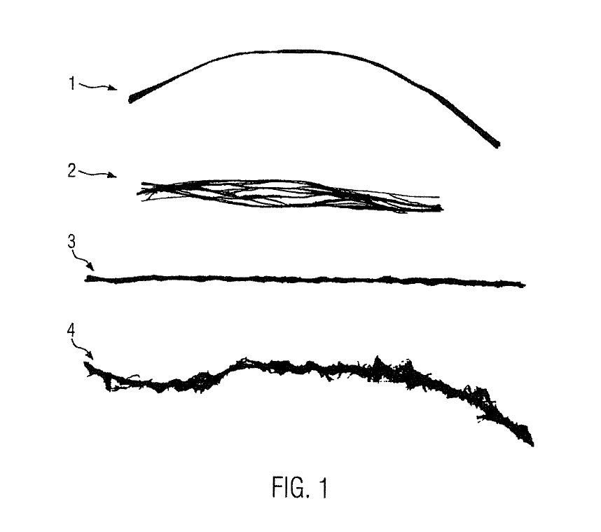

FIG. 1 shows various types of fiber strands. The differentiation from top to bottom is as follows:

Normal fiber strand 1, also referred to as roving, after production from the glass melting tank.

Open fiber strand 2, fiber strand 1 can by way of a suitable method be opened such that individual glass filaments become visible. The volume of the strand is increased so that fiber strand 2 is obtained.

Textured glass strand 3: This type of glass strand has no uniformity like in the normal unopened fiber strand, but instead a slight twist.

Effect-textured glass fiber strand 4: This type of glass strand has an extreme swirl in the glass filaments, while the strand interconnection is still maintained. This therefore has the effect that already a slight connection is created by the swirled filaments when such a strand is tangled.

FIG. 2 shows a schematic partial view of a molded part 10 on a part 12 of a system to be insulated, such as a silencer or muffler. Continuous molded part 10 is there formed according to the shape of the system to be insulated, where this view shows only a portion of molded part 10.

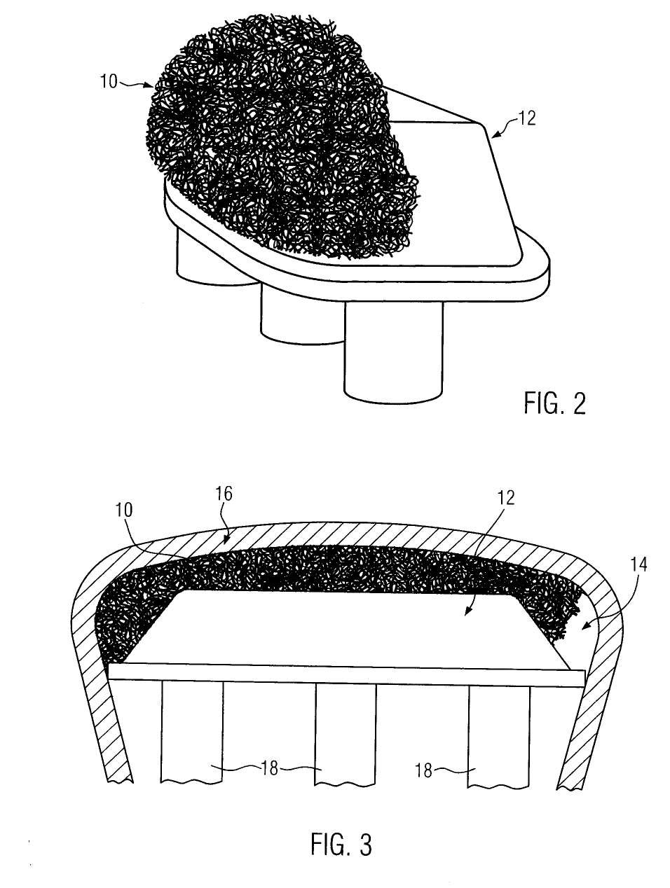

FIG. 3 shows a further partial schematic view in which continuous molded part 10 partially fills a cavity 14 of a silencer system. Cavity 14 is in this example shown between system or part 12 to be insulated and an outer wall 16. In the present view, the cavity is not entirely filled by continuous molded part 10. It is understood that also a different filling of cavity 14 can for reasons of application be given. Reference numeral 18 denotes inlet and outlet tubes for exhaust gas.

Continuous molded part 10 is a continuous molded part according to the present invention. A continuous fiber, for example, an effect-textured filament as outlined in FIG. 1, is there provided with an inorganic binder as a protective coat which encloses the fiber and in the cured state is shaping and protective. The coat can comprise a colloidal mineral, in particular a sol-gel based on water glass and silica sol. The sol-gel chemistry used can be based on an interplay of different types of water glass and different types of silica sol. Soluble precursors, i.e. starting materials, for sol-gel processes are, for example, sodium silicates (water glass), soluble oxides or alkoxides, i.e. alcoholates, of glass-forming compounds such as SiO₂, TiO₂, ZrO₂, and hydroxides such as boric acid, H₃BO₃, or sodium hydroxide, NaOH. However, for pure SiO2, for example, silicic acid esters are used. Further products that can be produced from sol-gel chemistry include aerogels, xerogels, powder, fiber and many more. The term sol-gel process is to be understood as a general term for methods of producing non-metallic inorganic or hybrid polymeric materials from colloidal dispersions. The water glass given in this example can be sodium and/or potassium and/or lithium water glass, where the silica sol particle size can be between 7 and 40 nm. The particle size of the silica sol particles, i.e. essentially the diameter of these particles, can in particular be divided into two ranges, namely firstly, particles having a size of about 7-20 nm in diameter or particles having a size of about 30-40 nm in diameter. A mixture of particles having diameters from the first range and of particles having diameters from the second range is possible. The water glass content of the sol-gel can amount to 25-75%, typically 35-65%, and in particular 45-55%, and the silica sol content of the sol-gel can amount to 25-75%, typically to 35-65%, and in particular to 35-55%. The sol-gel can be mixed with water, a portion of water can therefore be added. The water can be plain water and/or distilled water or it can be a mixture of both. The mixture of the water portion with the sol-gel can be given at a mixing ratio of 0-1:6, typically of 1:2 and in particular of 1:1. Here, these specifications for the water glass and the silica sol are to be understood as mass percentages of the respective raw material.

One problem with conventional inorganic binders has previously been that they could either not be used for the case of application for the reason that the binding forces on continuous fibers are not sufficient, or—which is problematic with a sol-gel system—the high basicity of the system bears the risk that the fibers are chemically attacked or even destroyed. It has frequently been attempted to use sol-gel systems based on water glass and silica sol, but this was always associated with the fiber being damaged. The inventors have established a sol-gel binder system which does not cause this effect due to its lower basicity. A composition of the binder has been found which has a lower pH-value than conventional sol-gel systems based on silica sol and water glass, and thereby also a lower chemical basicity. For the pH-value of the sol-gel, in particular 8≦pH≦9 may apply. With this pH-value a sufficiently low basicity, also known as alkalinity, can be obtained, whereby the fiber can be particularly well protected.

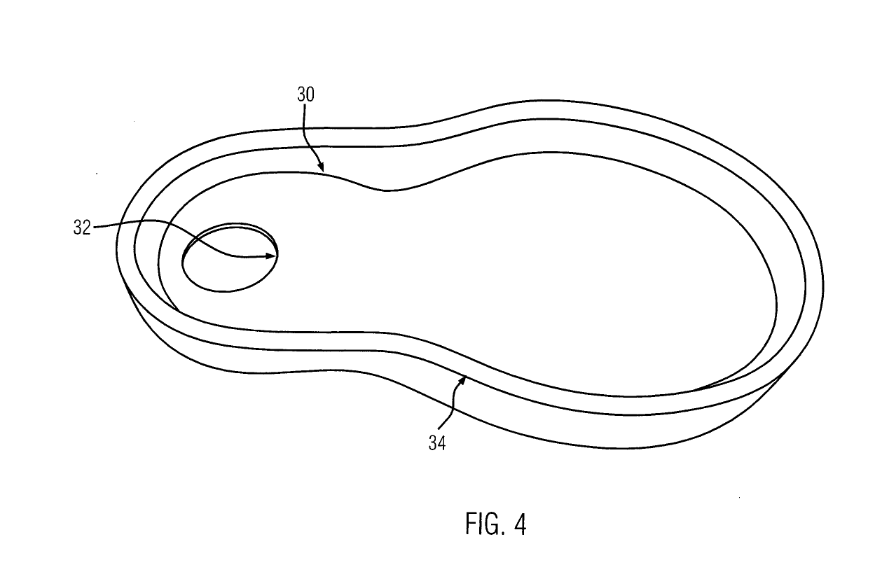

FIGS. 1-3 purely for reasons owed to drawing show the material of the continuous fiber molded parts in black, although this is typically a bright whitish material. Subsequent FIG. 4 appears only toward the shape obtained without drawing the material in black.

FIG. 4 shows a schematic view of a three-dimensionally shaped continuous molded part 30. This example shows a more complex shape of a continuous fiber molded part, where the continuous fiber molded part comprises both an edge 34 and an opening 32. The shape of continuous fiber molded part 30 is implemented according to the application. The mold shown is inherently stable and can be inserted as one piece into a system to be insulated. Continuous fiber molded part 30 is thereby insertable in a simple manner and also possibly exchangeable in a system to be insulated.

What is claimed is:

1. A continuous fiber molded part for silencers comprising:
a continuous fiber;
a coat of inorganic binder enclosing said continuous fiber.

2. The continuous fiber molded part according to claim 1, wherein:
said continuous fiber is an open or an effect-textured glass fiber; wherein said glass fiber is an E or ECR glass fiber; wherein said continuous fiber is given as a mat or scrim.

3. The continuous fiber molded part according to claim 1, wherein:
said inorganic binder comprises a colloidal mineral, in particular a sol-gel based on water glass and silica sol.

4. The continuous fiber molded part according to claim 3, wherein:
said water glass is a sodium and/or potassium and/or lithium water glass and wherein the silica sol particle size is between 7 and 40 nm.

5. The continuous fiber molded part according to claim 3, wherein:
a water glass content of said sol-gel amounts to 25-75%, typically to 35-65%, and in particular to 45-55%, and a silica sol content of said sol-gel amounts to 25-75%, typically to 35-65%, and in particular to 45-55%; wherein said sol-gel is mixed with a portion of water which comprises plain water and/or distilled water or a mixture of both, wherein a mixture of the water portion with said sol-gel is given at a mixing ratio of 0-1:6, typically of 1:2 and in particular of 1:1.

6. The continuous fiber molded part according to claim 3, wherein:
said sol-gel has a pH value of 8≦pH≦9.

7. A Method for producing a continuous fiber molded part comprising:
providing a continuous fiber which has a predefined density in a supply volume;
providing an inorganic binder;
applying said inorganic binder onto said continuous fiber so that said continuous fiber is enclosed in a coat-like manner;
curing said inorganic binder by applying heat.

8. The method according to claim 7, further comprising:
forming said continuous fiber molded part according to a predefined shape by way of cutting with a tool having severing edges, wherein said tool is typically heated by supplying heat.

9. The method according to claim 7, wherein:
curing is done by supplying heat at a temperature of at least 100° C., preferably between 250° C. and 400° C.

10. The method according to claim 7, wherein:
said inorganic binder is a colloidal mineral, in particular a sol-gel based on water glass and silica sol.

11. The method according to claim 10, wherein:
a water glass content of said sol-gel amounts to 25-75%, to typically 35-65%, and in to particular 45-55%, and a silica sol content of said sol-gel amounts to 25-75%, typically to 35-65%, and in particular to 45-55%; wherein said sol-gel is mixed with a portion of water which comprises plain water and/or distilled water or a mixture of both, wherein a mixture of said water portion with said sol-gel is given at a mixing ratio of 0-1:6, typically of 1:2 and in particular of 1:1.

12. The method according to claim 10, wherein:
said sol-gel has a pH value of 8≦pH≦9.

13. A method for the fabrication of silencers comprising:
providing a first coat shell;
providing a second coat shell or a component directly conducting hot gas;
providing a continuous fiber molded part according to claim 7;
introducing the continuous fiber molded part between the first and the second coat shell or between the first coat shell and the component directly conducting hot gas.

14. The method according to claim 13, wherein:
the step of introducing said continuous fiber molded part comprises inserting and/or casting and/or blowing and/or pushing the continuous fiber molded part in between the first and the second coat shell or between the first coat shell and the component directly conducting hot gas.

15. A silencer fabricated following the method according to claim 13.

16. A method of making a silencer comprising the steps of:
coating a continuous fiber with a colloidal mineral formed by a sol-gel process having a pH ranging from 8 to 9;
forming a molded part with the continuous fiber; and
placing the molded part around a part to be silenced,
whereby the continuous fiber is not chemically attacked by the sol-gel process.

17. A method of making a silencer as in claim 16 wherein:
the sol-gel process is based on water glass and silica sol.
